(19) United States
(12) Patent Application Publication
(10) Pub. No.: US 2022/0076361 A1
(43) Pub. Date: Mar. 10, 2022

(54) SYSTEM FOR VALIDATING A COOKING PROCEDURE AT A COOKING FACILITY

(71) Applicant: TECHNOLOGY LICENSING CORPORATION, Fort Lauderdale, FL (US)

(72) Inventors: BEN KOETHER, FORT LAUDERDALE, FL (US); EDWARD MUSIAL, MONROE, CT (US); MIKE KEEFE, BROOKFIELD, CT (US)

(21) Appl. No.: 17/466,678

(22) Filed: Sep. 3, 2021

Related U.S. Application Data
(60) Provisional application No. 63/075,532, filed on Sep. 8, 2020.

(51) Int. Cl. G06Q 50/12; G06K 9/00; G06K 9/62; H04N 5/247

(52) U.S. Cl. CPC G06Q 50/12; G06K 9/00288; H04N 5/247; G06K 9/6201; G06K 9/00771; G06K 9/00926

(57) ABSTRACT

A system for validating a cooking procedure includes a camera for capturing an image of an operator performing a cooking procedure at a cooking station, and capturing an image of the performed cooking procedure. A library stores images of operators authorized to perform the cooking procedure and images of a correct performance of the cooking procedure. The library stores two or more remedial actions, a respective remedial action corresponding to a number of misoperations of the cooking procedure by the operator. A manager communicates with the camera and the library to receive the image of the operator and the image of the cooking procedure performed by the operator. The manager compares the operator image with the images of authorized operators for a cooking procedure to determine whether the image of the operator is an image of an authorized operator for a cooking procedure. The manager compares the cooking procedure image as performed with images of the correct cooking procedure. The manager determines that a misoperation has occurred if one of the images of the operator does not match an image of an authorized operator or the image of the performed cooking procedure does not match the stored image of the performed cooking procedure.

### CROSS REFERENCE TO RELATED APPLICATION

This application claims the benefit of U.S. Provisional Application No. 63/075,532 filed on Sep. 8, 2020, the entire disclosure of which is hereby incorporated in its entirety.

### BACKGROUND OF THE INVENTION

The present invention relates to a control system for a cooking facility, and more particularly, a control system for validating and/or tracking the performance of a cooking procedure by an appropriate person to perform a specific task.

In commercial cooking facility food preparation areas there are a number of, and a variety of, stations in which functions from breading, to frying, to baking, and even maintenance are to be performed by certain tasked employees. To comply with internal procedures, and even with the Food Safety Modernization Act, some activities such as fryer operation or maintenance are to be performed by specific authorized personnel because of training required and the difficulty or danger inherent in the task.

Currently, solutions exist which can detect whether operation of a specific cooking appliance was performed. However, there is currently no manner to determine if the operation was performed by the correct person, or often even in an appropriate manner. Furthermore, when done inappropriately, there is no remedial action available because of the lack of ability to identify with certainty the person responsible for operation. As a result, there is also no system wide accounting of all incorrect operation of a cooking appliance on a person by person basis.

Accordingly, there is a need for a system for a cooking appliance that can track not only that a specific operation was performed at the cooking appliance, but that the correct person performed the operation, and if not performed correctly, that the person who performed the operation be given remedial training.

### SUMMARY OF THE INVENTION

A system for validating a cooking procedure at a cooking facility includes a camera for capturing an image of an operator performing a cooking procedure at a cooking station, and capturing an image of the cooking procedure performed at the cooking station. A library stores images of operators authorized to perform the cooking procedure at the cooking station and images of a correct cooking procedure to be performed at the cooking station. The library stores two or more remedial actions, a respective remedial action corresponding to a number of misoperations of the cooking procedure by the operator. A manager communicates with the camera and the library to receive the image of the operator and the image of the cooking procedure performed by the operator. The manager compares the image of the operator with the images of operators authorized to perform the cooking procedure to determine whether the image of the operator is an image of an operator authorized to perform the cooking procedure The manager compares the image of the cooking procedure as performed with the images of the correct cooking procedure to be performed. The manager determines that a misoperation has occurred if one of the images of the operator does not match an image of an operator authorized to perform the procedure and the image of the cooking procedure as performed does not match the image of the cooking procedure to be performed.

### BRIEF DESCRIPTION OF THE DRAWINGS

The features and advantages of the present invention will become more readily apparent from the following detailed description of the invention in which like elements are labeled similarly and in which:

FIG. 1 is a schematic drawing of the system for operating a cooking appliance in accordance with the invention;

FIG. 2 is a schematic diagram of the face of a control panel constructed in accordance with one embodiment of the invention; and

FIG. 3 is a flowchart for the operation of the system for monitoring and operating a cooking appliance in accordance with the invention.

### DETAILED DESCRIPTION OF THE PREFERRED EMBODIMENTS

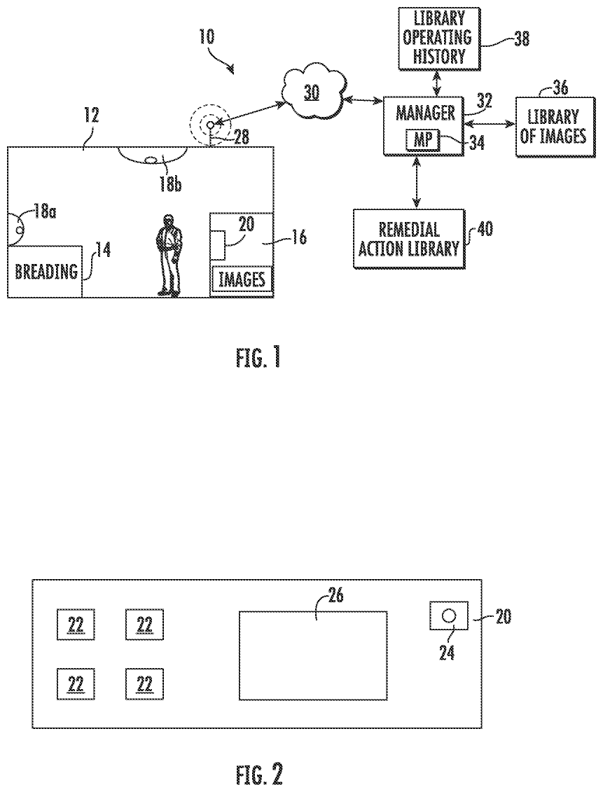

Reference is made to FIG. 1 in which a system 10 for tracking, validating and remediating the operator of a cooking appliance is provided. System 10 includes a food preparation facility 12, a manager in operative communication with facility 12, and one or more libraries 36, 38 and 40 in communication with manager 32 for storing information operated upon by manager 32.

Facility 12 is a commercial kitchen in which several food preparation steps are performed at a variety of distinct preparation stations. By way of nonlimiting example there is a breading station 14 where food such as chicken, fish, veal or the like is breaded prior to a cooking process. There is often at least a second preparation station comprised of a cooking appliance 16; most commonly a fryer or an oven for cooking the prepared food, but may be any controlled appliance used to prepare food. In accordance with the invention, there are cameras 18, 24 disposed within facility 12 so as to be associated with a respective preparation station 14, 16 as well as at large (within the facility, but not necessarily associated with a preparation station).

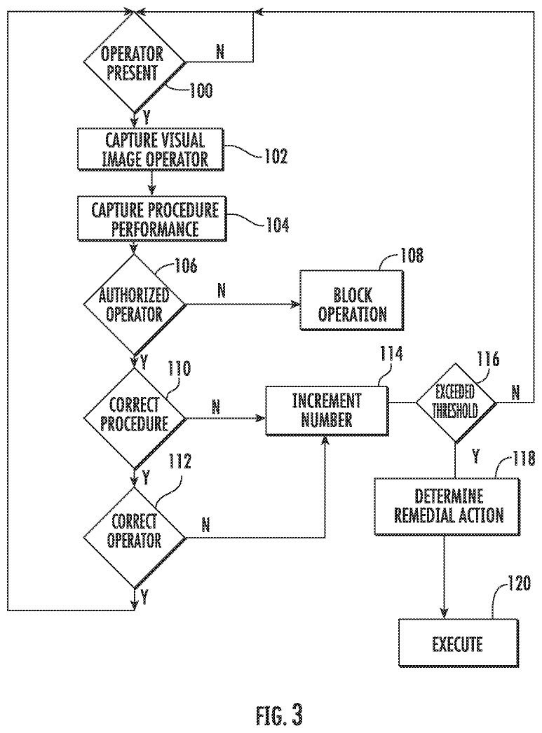

Cooking appliance 16 includes a control panel 20. As seen in FIG. 2, control panel 20 includes a number of control inputs 22 which, as known in the art, may be physical or virtual buttons; each button corresponding to a different control parameter for controlling the cooking appliance. For the purposes of this description one or more control parameters for operating a cooking appliance to prepare a specific food item is called a recipe. Therefore, each distinct control button 22 corresponds to operating control appliance 16 in accordance with a different recipe. Control panel 20 may also include an audio visual display 26 and a camera 24 positioned to capture an image of an operator 60 as they operate the cooking appliance 16 with which control panel 20 is associated.

It should be noted that camera 24 is disposed on cooking appliance 16 to optimize capturing an image of operator 60 as they operate control appliance 16 which may be on or away from control panel 20. Because control panel 20 may be a mechanically activated control panel or a virtual graphical user interface screen, audiovisual display 26 may be a physical television type screen, or a region within the graphical user interface dedicated to display.

System 10 also includes a manager 32 for processing the outputs from cameras 18, 24, monitoring the operations of breading station 14 and cooking appliance 16, and monitoring which operator 60 actually performs the monitored task. Manager 32 includes a microprocessor 34 for processing inputs from a variety of sources as will be discussed below. In a preferred non limiting embodiment manager 32 communicates with cooking facility 12, and the stations thereon through cloud 30 utilizing an antenna 28 operatively communicating with each station, and associated equipment (camera, microprocessor) within facility 12.

System 10 also includes libraries 36, 38, 40 in communication with manager 32 for storing and making available information to be operated upon by microprocessor 34 of manager 32. A first library 36 is a library of images; the faces of any operator 60 who may be associated with a facility 12. The images are of the faces of the respective operators 60, and information stored in library 36 may also include the associated operator's name, and a list of approved operations for an operator 60; each mapped to the facial image. A second library 38 is an operation library, storing images of proper execution of an operation at a station 14, 16, or appropriate sensor responses for operation of a particular cooking appliance 16. Lastly, a remedial action library stores remedial actions associated with responses to misoperation of a station; extending the gamut from storing videos of proper execution of tasks at the various stations 14, 16 to be shown to an operator to a dismissal determination when misoperation becomes excessive.

Libraries 36, 38 and 40 are each shown as independent libraries in communication with manager 32 for ease of explanation, but it should be readily understood by those skilled in the art that the libraries could form a single library in communication with one or more managers 32. Also each library can be a dedicated library solely for operation of a single facility, but in the preferred embodiment the libraries 36, 38 and 40 are associated with two or more facilities 12 and/or two or more managers 32. Therefore, in one embodiment a local images library 50 may be provided at facility 12 or even associated with a specific cooking appliance 16 to control which appliances can even be operated by specific operators 60.

At the outset system 10 is initialized by taking a visual image of each operator 60 within a facility 12 and uploading the image to library 36. The image is mapped in library 36 to operations which an operator 60 is authorized to, and expected to perform. Images of the correct performance of a process at a station in a facility 12 are stored in library 38. Lastly remedial actions, including videos for correcting behavior are stored in remedial action library. A list mapping an appropriate remedial behavior with a number of past infractions may also be stored at library 40, or at a manager 32.

The operation of system 10 will now be described, with reference to FIG. 3, in connection with cooking appliance 16. To perform a cooking operation, in a step 100, an operator is present in the vicinity of cooking appliance 16, sufficiently close for camera 24 to capture a facial image of operator 60 as operator 60 operates cooking appliance 16 in a step 102. In a step 104 sensors, such as buttons 22, or a basket motion detector (fryer) detect operation as known in the art, or camera 24 filming operation captures the task being performed at cooking appliance 16.

In a fryer the task may be operating control panel 20 to drop a basket of food into the fryer for a particular recipe corresponding to a selected button 22. The performance of this activity may be determined by sensing operation of button 22, a switch at the vat of a fryer triggered by movement of the basket, or if the operation is maintenance, from sensors which monitor the draining of the cooking medium and removal and insertion of a filter. At the same time, or instead of, operation of cooking apparatus 16 is filmed by appliance camera 24, and/or a facility camera 18b, remote form cooking appliance 16, to determine cooking parameters such as, which button 22 was selected, that the correct food types and amounts corresponding to a selected button 22 were actually loaded, or that a new filter was actually put into the appliance 16.

In a step 106 it is determined whether an authorized operator 60 is operating cooking appliance 16. In a preferred embodiment, in step 106 the visual image captured in step 102 is compared locally, by a microprocessor at facility 12, to a library 36 of facial images of authorized personnel located at facility 12. If the face captured in step 103 is not in library 36, or does not correspond to an operation for which operator 60 is authorized, then operation of cooking appliance 16 is blocked in a step 108. It should be noted that step 106, may also be performed before step 104.

In another embodiment, without the blocking function of step 106, it is the determination of the authorized operator which is combined with determination of appropriate procedure in step 110. In a step 110, it is determined whether a cooking operation is properly performed. This is a two step process. First, proper performance is a function of who performs the operation and how the operation is performed. Therefore in step 110, the facial image captured by camera 24, and the performance of the operation as determined by cameras 18b, 24 and/or sensors (known in the art, but partially shown), are transmitted to manager 32.

Manager 32, utilizing image recognition methodologies as known in the art, first compares the visual image of operator 60 to images stored in image library 36 to determine for which operations operator 60 is approved; if any. If manager 32 can not match the captured visual image to an image of an operator authorized to perform the operation, then manager 32 determines that the correct operation was not performed and stores the operation improperly performed with the identity of operator 60 who attempted the procedure.

Even if an authorized person performed the procedure, it is still determined in step 110 whether the procedure was correctly performed. In the example of a fryer, an authorized operator may select the wrong recipe (french fries for chicken preparation), or an extra crispy button 22, when regular frying was desired, or cooking twelve (large order) wings when only six (small order) were needed. The authorized operator may try to underperform maintenance, by going through the motions of changing the fryer filter, opening and closing the door, or putting the old filter back in.

In step 110 manager 32 also receives sensor inputs from cooking appliance 16 and images from cameras 18b, 24 corresponding to operation performance. Manager 32 compares this information to the data and images stored in library 38 corresponding to correct performance of the operation. If the procedure as performed by operator 60 does not match the operation as stored in library 38, the manager 32 will again determine that the correct procedure was not performed.

Manager 32 maintains a record of which operators 60 have performed an incorrect procedure, whether unauthorized, or incorrectly performed. This number associated with a respective specific operator may be stored in manager 32 or operation library 38. Each time it is determined that an operator 60 has incorrectly performed a procedure, the stored number is incremented in a step 114. Microprocessor 34 of manager 32 then determines whether the number of improper operations by a specific operator 60 has exceeded a predetermined threshold. If not the process returns to step 100.

Library 40 maps each infraction to a number of occurrences and a remedial action. If the threshold has been exceeded then in a step 118 manager 32 communicates with remedial action library 40 to determine a required remedial action corresponding to the infraction number and type.

Manager 32 compares the counted number from step 114 and selects a remedial action. A first infraction may correspond to a remedy as stored in library 38; a warning and remedial training corresponding to a number of erroneous operations as stored in remedial action library 40. The need for warning is transmitted to facility 12 to a supervisor of operator 60 to deliver the warning. The remedial training may be by way of an instructional video selected by manager 32 to be transmitted to display panel 26 of control panel 20 in a step 120. In this way remedial action is not only performed in a timely manner, but at the site where the operator can better connect operation to the device 16 upon which the operation is to take place in the future; aiding in remembering.

If the count escalates to exceed a second predetermined number then a different, escalated remedial action stored in library 40, corresponding to a second number, is selected in step 118, such as probation and a warning. If the number escalates beyond yet another predetermined threshold, then a third remedial action stored in library 40, may be selected; such as dismissal. A number necessary for triggering each remedial action may also vary not just for count, but repetitiveness, and type of infraction.

It should be readily understood that manager 32 can be a local processor at the facility. However as seen in the exemplary embodiment of FIG. 1 manager 32 may communicate through cloud 30 enabling monitoring of two or more locations.

The problem often arises that one authorized operator 60, not responsible for a specific task performs a task for the authorized operator responsible for performing the task. While not an issue if happening as a one off, it can become an issue if such covering of one operator 60 not assigned to a task for another operator 60 who is becomes repetitive. Therefore, image library 36 and/or library 50 not only stores authorizations for each operator 60, but also stores operations for which each operator 60 has primary responsibility associated with their images. Therefore, in a preferred non limiting embodiment, even if in a step 110 if it is determined that an authorized operator 60 correctly performed a procedure; it is determined in a step 112 whether the correct operator 60 performed the procedure.

If it is determined that the correct operator 60 performed the operation then the process returns to step 100. If it an incorrect person performing the operation, then the process returns to step 114, where the number of infractions associated with each operator is incremented and steps 116-120 are performed as described above.

The above example was made in connection with a cooking appliance 16 such as a fryer or a convention oven. However, system 10 operating in substantially the same manner is capable of monitoring cooking operations such as food preparation in which an appliance is not involved. By way of nonlimiting example, in many commercial cooking facilities, foods must be breaded, or sauce prepared prior to frying or baking. Some recipes may call for single coating of breading, while others may require double breading. This type of operation can be monitored, verified and remediated in accordance with the invention.

In facility 12 a breading operation occurs at breading station 14 prior to cooking in cooking appliance 16. A recipe may call for double breading of a protein. Therefore in accordance with the invention, camera 18a located at breading station 14 captures the image of operator 60 as they perform tasks at breading station 14. Camera 18a also captures the breading procedure performed by operator 60. It is then determined, as discussed above, whether the procedure was properly performed; i.e. single breading or double breading as required. If unauthorized personnel perform the procedure, and/or the procedure was improperly performed by any operator 60, remedial action would be taken as described above. Lastly, utilizing the image captured at camera 18a can be determined whether the correct operator 60 performed the procedure, and if not, remedial action can the can be taken when needed.

With respect to the foregoing embodiments of the invention which have been described, it should be recognized that communications, whether between the appliance, sensor, libraries, microprocessor, or any combination thereof, may be accomplished by any suitable wireless or wired means for the intended application and is a matter of design choice. Preferably, communications are effectuated through wireless communication platforms whose technology is well-established and known to those skilled in the art. More preferably, the wireless communications are performed over the Internet, or the cloud, using established nationwide wireless networks. However, these links may also be conventional, wire based connections such as through standard telecommunication lines, T1 service or the like.

It should be readily understood from the above, that while the processes described in connection with cooking, any process having devices to be operated upon in a specific way to combine elements in connection with a recipe is applicable to the method and system described above. By way of nonlimiting example pharmaceutical and chemical manufacturing could be performed pursuant to the system and method described above.

It should also be appreciated by those skilled in the art that individual cooking appliances may be communicating with a manager in the form of any of the numerous mobile communication devices. These devices may include, but are not limited to cellular and other wireless communication devices which may be embodied in a phone, laptop or notebook computer, personal digital assistant or the like. These communication devices may effectuate contact with the appliances via cellular, wireless or Internet connections using established nationwide wireless networks or the cloud.

It should further be recognized that the invention is not limited to the particular embodiments described above. Accordingly, numerous modifications can be made without departing from the spirit of the invention and scope of the claims appended hereto. For example, it will also be appreciated by those skilled in the art that the invention is not limited to restaurant applications, but may be employed in any commercial, industrial or institutional application wherein a cooking procedure is performed. Additionally, the manager, libraries, cameras and cooking appliances, may all be local to the facility, or may be communicating across a distributed network. Moreover, the invention is not limited to use with any particular type of food product or appliance, and will find broad applicability in the food preparation service industry wherever the invention may be feasibly employed. Thus, the invention may be used with ovens, fryers, proofer's and the like which may be provided with microprocessor-based controller's to provide a communication interface with the system in network of the invention. Accordingly, these appliances may be cloud enabled to effectuate communications with the system via the Internet.

What is claimed is:

1. A system for validating a cooking procedure at a cooking facility comprising:
a camera for capturing an image of an operator performing a cooking procedure at a cooking station, and capturing an image of the cooking procedure performed at the cooking station;
a library storing images of one or more operators authorized to perform the cooking procedure at the cooking station; images of a correct cooking procedure to be performed at the cooking station; and
a manager communicating with the camera and the library to receive the image of the operator and the image of the cooking procedure performed by the operator; the manager communicating with the library, and comparing the image of the operator with the images of the one or more operators authorized to perform the cooking procedure and, as a result of the comparison, determining whether the image of the operator is an image of an operator authorized to perform the cooking procedure; and comparing the image of the cooking procedure as performed with the images of the correct cooking procedure to be performed, and determining that a misoperation has occurred if one of i.) the image of the operator does not match an image of an operator authorized to perform the procedure and ii.) the image of the cooking procedure as performed does not match the image of the cooking procedure to be performed.

2. The system of claim 1, wherein the camera is disposed on a cooking appliance upon which the procedure is performed.

3. The system of claim 2, further comprising a second camera disposed away from the cooking appliance and positioned to record the performance of the operation.

4. The system of claim 3, wherein the manager receives a first image from the camera, receives a second image form the second camera, and determines that the misoperation occurs as a function of at least one of the first image and second image.

5. The system of claim 1 comprising:
a second library for storing one or more remedial operations; each remedial operation corresponding to one or more misoperations. and
an audiovisual display for outputting audio instructions and visual images; and
the manager communicating with the second library and audiovisual display, the manager determining a remedial action as function of a determined misoperation; and causing the remedial action to be broadcast at the audiovisual display.

6. The system of claim 6, wherein the manager counts a number of misoperations associated with each respective operator, and selects a remedial action as function of a type of misoperation and a number of misoperations performed by a respective operator.

7. The system of claim 6, wherein the remedial action is one of a warning audio delivered at the audio visual device, a remedial video demonstrating a correct way to perform the operation displayed at the audio visual device; and a message transmitted to a supervisor.

8. The system of claim 6 wherein the audiovisual display is disposed on the cooking station.

9. The system of claim 6, wherein the manager prevents operation of the cooking appliance when the image of the operator is not the image of an operator authorized to perform the procedure.

10. A method for validating a cooking procedure performed at a cooking station within a cooking facility comprising the steps of:
capturing a visual image of an operator performing a cooking procedure at a cooking station;
capturing an image of the cooking procedure performed at the cooking station;
comparing the captured visual image of the operator with one or more visual images of operators authorized to operate the cooking appliance; and determining whether the image of the operator is an image of an operator authorized to perform the cooking procedure;
comparing the captured visual image of the cooking procedure performed at the cooking station with one or more visual images of a correct procedure performed at the cooking appliance;
and determining as a function of the comparison whether a misoperation of the cooking appliance has occurred; and
and determining that a misoperation of the cooking appliance has occurred if one of i.) the image of the operator does not match an image of an operator authorized to perform the procedure and ii.) the image of the cooking procedure as performed does not match the image of the cooking procedure to be performed.

11. The method for validating a cooking procedure of claim 10, further comprising the steps of:
storing one or more remedial operations in a library; each remedial operation corresponding to one or more misoperations. and
providing an audiovisual display for outputting audio instructions and visual images; and
determining a remedial action as a function of a determined misoperation; and causing the remedial action to be broadcast at the audiovisual display.

12. The method for validating a cooking procedure of claim 11, further comprising the step of associating a number of misoperations with each respective operator, and selecting a remedial action as a function of a type of misoperation and a number of misoperations performed by a respective operator.

13. The method of verifying of claim 12, wherein the remedial action is one of a warning audio delivered at the audio visual device, a remedial video demonstrating a correct way to perform the operation displayed at the audio visual device; and a message transmitted to a supervisor.

14. The method of verifying of claim 11, wherein operation of the cooking appliance is prevented when the image of the operator is not the image of an operator authorized to perform the procedure.
